(19) United States
(12) Patent Application Publication
(10) Pub. No.: US 2022/0121213 A1
(43) Pub. Date: Apr. 21, 2022

(54) HYBRID PLANNING METHOD IN AUTONOMOUS VEHICLE AND SYSTEM THEREOF

(71) Applicant: Automotive Research & Testing Center, Changhua County (TW)

(72) Inventors: Tsung-Ming HSU, Changhua County (TW); Yu-Rui CHEN, Changhua County (TW); Cheng-Hsien WANG, Changhua County (TW); Zhi-Hao ZHANG, Changhua County (TW)

(21) Appl. No.: 17/076,782

(22) Filed: Oct. 21, 2020

(51) Int. Cl. G05D 1/02; G05D 1/00

(52) U.S. Cl. CPC G05D 1/0221; G05D 2201/0213; G05D 1/0088

(57) ABSTRACT

A hybrid planning method in an autonomous vehicle is performed to plan a best trajectory function of a host vehicle. A parameter obtaining step is performed to sense a surrounding scenario of the host vehicle to obtain a parameter group to be learned. A learning-based scenario deciding step is performed to receive the parameter group to be learned and decide one of a plurality of scenario categories that matches the surrounding scenario of the host vehicle according to the parameter group to be learned and a learning-based model. A learning-based parameter optimizing step is performed to execute the learning-based model with the parameter group to be learned to generate a key parameter group. A rule-based trajectory planning step is performed to execute a rule-based model with the one of the scenario categories and the key parameter group to plan the best trajectory function.

### BACKGROUND

### Technical Field

The present disclosure relates to a planning method in an autonomous vehicle and a system thereof. More particularly, the present disclosure relates to a hybrid planning method in an autonomous vehicle and a system thereof.

### Description of Related Art

As autonomous vehicles become more prominent, many car manufacturers have invested in the development of autonomous vehicles, and several governments plan on operating mass transit systems using autonomous vehicles. In some countries, experimental autonomous vehicles have been approved.

In operation, an autonomous vehicle is configured to perform continuous sensing at all relative angles using active sensors (e.g., a lidar sensor) and/or passive sensors (e.g., a radar sensor) to determine whether an object exists in the proximity of the autonomous vehicle, and to plan a trajectory for the autonomous vehicle based on detected information regarding the object(s).

Currently, conventional planning methods in the autonomous vehicle for an object avoidance include two models. One is a rule-based model, and the other is an Artificial Intelligence-based model (AI-based model). The rule-based model needs to evaluate each of the results, and it is only applicable to a scenario within the restricted conditions. The trajectory of the AI-based model will be discontinuous, and the generation of the trajectory and the speed is not stable. Therefore, a hybrid planning method in an autonomous vehicle and a system thereof which are capable of processing a plurality of multi-dimensional variables at the same time, being equipped with learning capabilities and conforming to the dynamic constraints of the host vehicle and the continuity of trajectory planning are commercially desirable.

### SUMMARY

According to one aspect of the present disclosure, a hybrid planning method in an autonomous vehicle is performed to plan a best trajectory function of a host vehicle. The hybrid planning method in the autonomous vehicle includes performing a parameter obtaining step, a learning-based scenario deciding step, a learning-based parameter optimizing step and a rule-based trajectory planning step. The parameter obtaining step is performed to drive a sensing unit to sense a surrounding scenario of the host vehicle to obtain a parameter group to be learned and store the parameter group to be learned to a memory. The learning-based scenario deciding step is performed to drive a processing unit to receive the parameter group to be learned from the memory and decide one of a plurality of scenario categories that matches the surrounding scenario of the host vehicle according to the parameter group to be learned and a learning-based model. The learning-based parameter optimizing step is performed to drive the processing unit to execute the learning-based model with the parameter group to be learned to generate a key parameter group. The rule-based trajectory planning step is performed to drive the processing unit to execute a rule-based model with the one of the scenario categories and the key parameter group to plan the best trajectory function.

According to another aspect of the present disclosure, a hybrid planning system in an autonomous vehicle is configured to plan a best trajectory function of a host vehicle. The hybrid planning system in the autonomous vehicle includes a sensing unit, a memory and a processing unit. The sensing unit is configured to sense a surrounding scenario of the host vehicle to obtain a parameter group to be learned. The memory is configured to access the parameter group to be learned, a plurality of scenario categories, a learning-based model and a rule-based model. The processing unit is electrically connected to the memory and the sensing unit. The processing unit is configured to implement a hybrid planning method in the autonomous vehicle including performing a learning-based scenario deciding step, a learning-based parameter optimizing step and a rule-based trajectory planning step. The learning-based scenario deciding step is performed to decide one of the scenario categories that matches the surrounding scenario of the host vehicle according to the parameter group to be learned and the learning-based model. The learning-based parameter optimizing step is performed to execute the learning-based model with the parameter group to be learned to generate a key parameter group. The rule-based trajectory planning step is performed to execute the rule-based model with the one of the scenario categories and the key parameter group to plan the best trajectory function.

### BRIEF DESCRIPTION OF THE DRAWINGS

The present disclosure can be more fully understood by reading the following detailed description of the embodiment, with reference made to the accompanying drawings as follows:

FIG. 1 shows a flow chart of a hybrid planning method in an autonomous vehicle according to a first embodiment of the present disclosure.

FIG. 2 shows a flow chart of a hybrid planning method in an autonomous vehicle according to a second embodiment of the present disclosure.

FIG. 3 shows a schematic view of a message sensing step of the hybrid planning method in the autonomous vehicle of FIG. 2.

FIG. 4 shows a schematic view of a plurality of input data and a plurality of output data of the message sensing step of the hybrid planning method in the autonomous vehicle of FIG. 2.

FIG. 5 shows a schematic view of a data processing step of the hybrid planning method in the autonomous vehicle of FIG. 2.

FIG. 6 shows a schematic view of the hybrid planning method in the autonomous vehicle of FIG. 2, applied to an object avoidance in the same lane.

FIG. 7 shows a schematic view of the hybrid planning method in the autonomous vehicle of FIG. 2, applied to an object occupancy scenario.

FIG. 8 shows a schematic view of the hybrid planning method in the autonomous vehicle of FIG. 2, applied to a lane change.

FIG. 9 shows a schematic view of a rule-based trajectory planning step of the hybrid planning method in the autonomous vehicle of FIG. 2.

FIG. 10 shows a block diagram of a hybrid planning system in an autonomous vehicle according to a third embodiment of the present disclosure.

### DETAILED DESCRIPTION

The embodiment will be described with the drawings. For clarity, some practical details will be described below. However, it should be noted that the present disclosure should not be limited by the practical details, that is, in some embodiment, the practical details is unnecessary. In addition, for simplifying the drawings, some conventional structures and elements will be simply illustrated, and repeated elements may be represented by the same labels.

It will be understood that when an element (or device) is referred to as be “connected to” another element, it can be directly connected to the other element, or it can be indirectly connected to the other element, that is, intervening elements may be present. In contrast, when an element is referred to as be “directly connected to” another element, there are no intervening elements present. In addition, the terms first, second, third, etc. are used herein to describe various elements or components, these elements or components should not be limited by these terms. Consequently, a first element or component discussed below could be termed a second element or component.

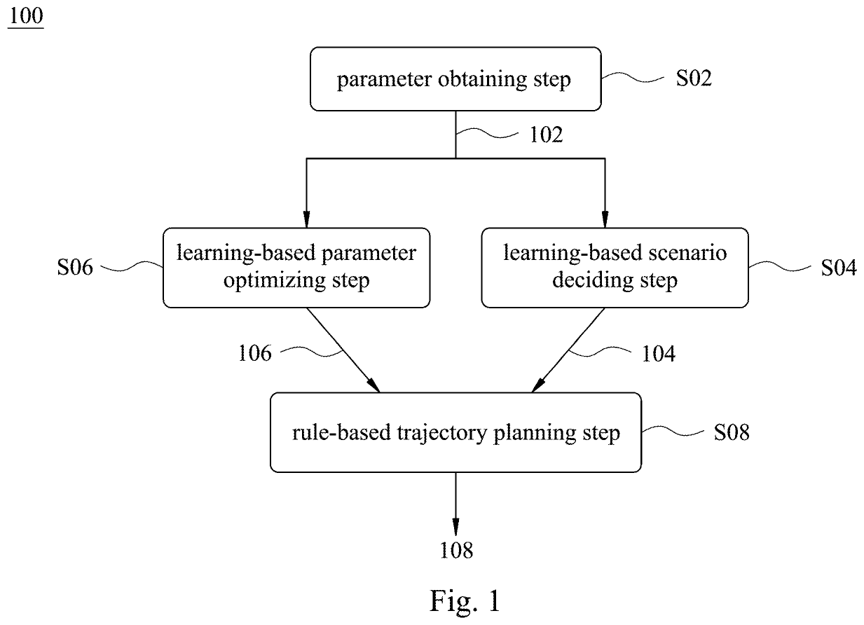

FIG. 1 shows a flow chart of a hybrid planning method 100 in an autonomous vehicle according to a first embodiment of the present disclosure. The hybrid planning method 100 in the autonomous vehicle is performed to plan a best trajectory function 108 of a host vehicle. The hybrid planning method 100 in the autonomous vehicle includes performing a parameter obtaining step S02, a learning-based scenario deciding step S04, a learning-based parameter optimizing step S06 and a rule-based trajectory planning step S08.

The parameter obtaining step S02 is performed to drive a sensing unit to sense a surrounding scenario of the host vehicle to obtain a parameter group 102 to be learned and store the parameter group 102 to be learned to a memory. The learning-based scenario deciding step S04 is performed to drive a processing unit to receive the parameter group 102 to be learned from the memory and decide one of a plurality of scenario categories 104 that matches the surrounding scenario of the host vehicle according to the parameter group 102 to be learned and a learning-based model. The learning-based parameter optimizing step S06 is performed to drive the processing unit to execute the learning-based model with the parameter group 102 to be learned to generate a key parameter group 106. The rule-based trajectory planning step S08 is performed to drive the processing unit to execute a rule-based model with the one of the scenario categories 104 and the key parameter group 106 to plan the best trajectory function 108. Therefore, the hybrid planning method 100 in the autonomous vehicle of the present disclosure utilizes the learning-based model to learn the driving behavior of the object avoidance, and then combines the learning-based planning with the rule-based trajectory planning to construct a hybrid planning, so that the hybrid planning can not only process a plurality of multi-dimensional variables at the same time, but also be equipped with learning capabilities and conform to the continuity of trajectory planning and the dynamic constraints of the host vehicle HV. Each of the above steps of the hybrid planning method 100 is described in more detail below.

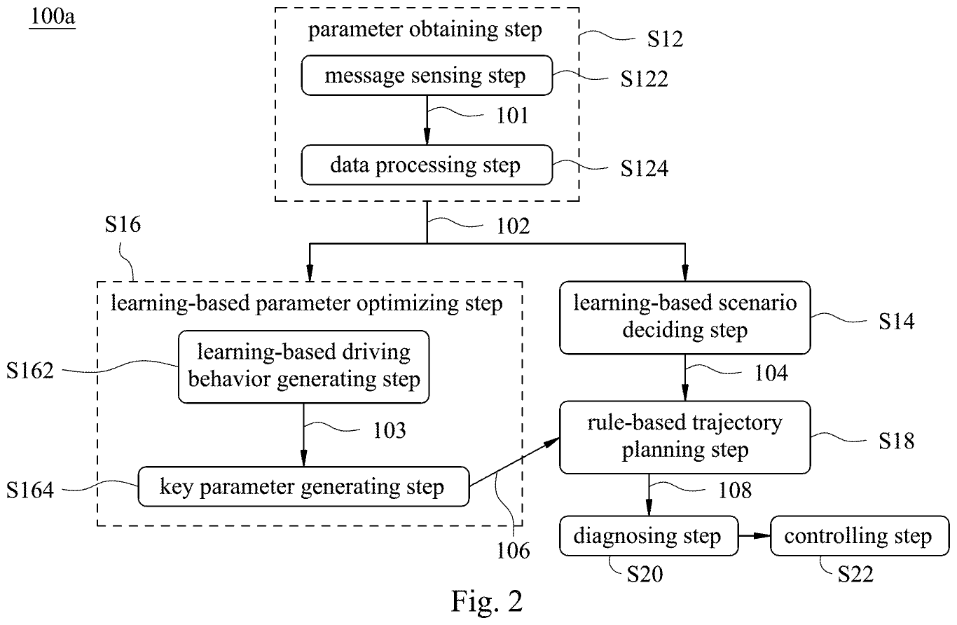

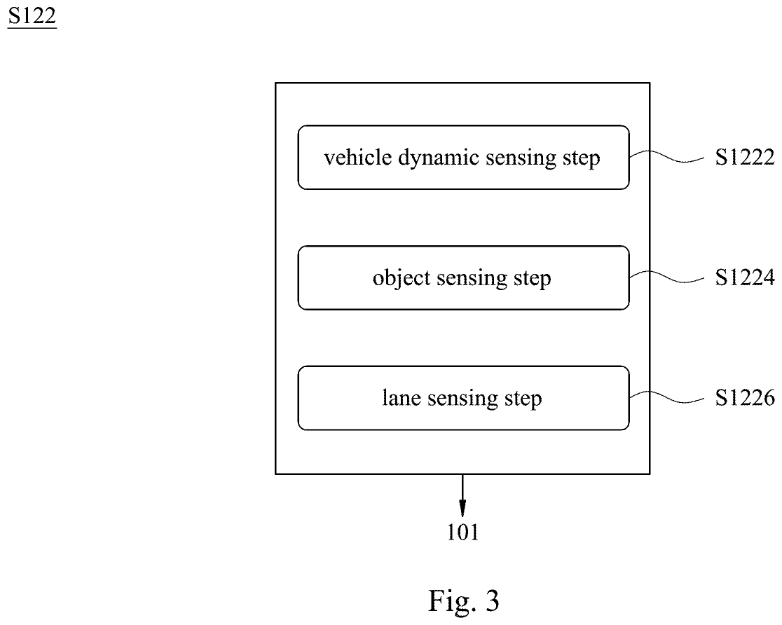

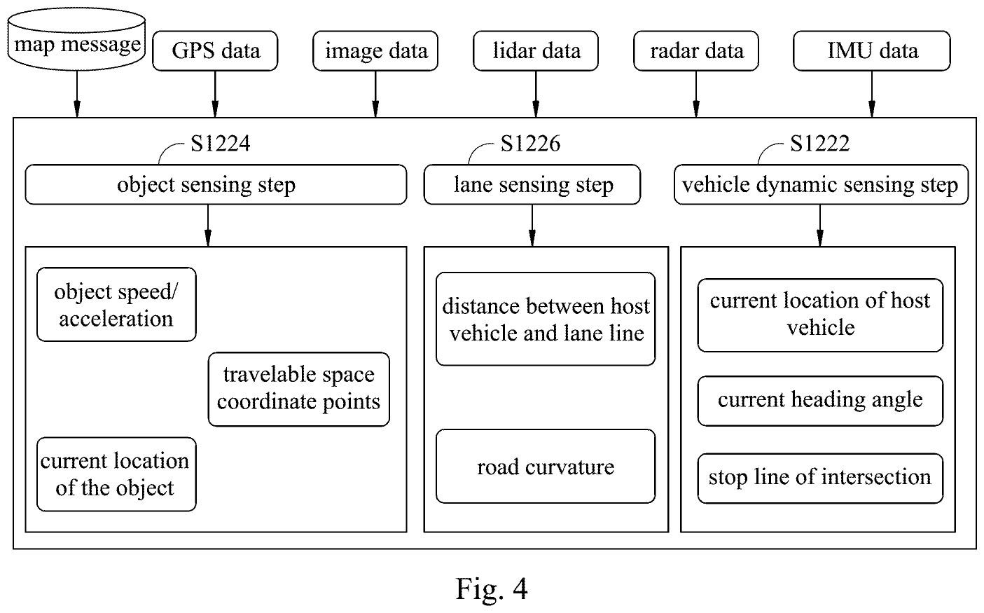

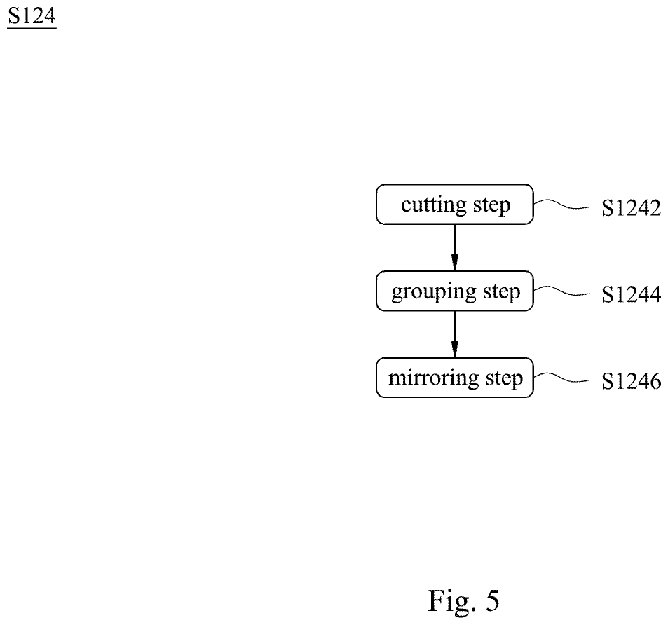

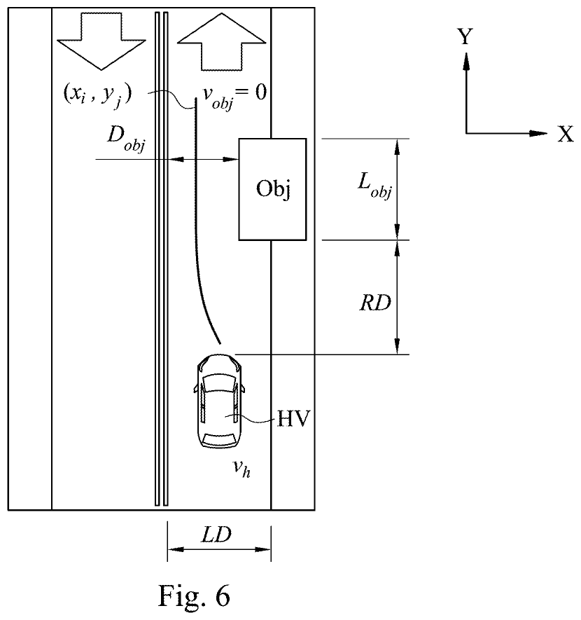

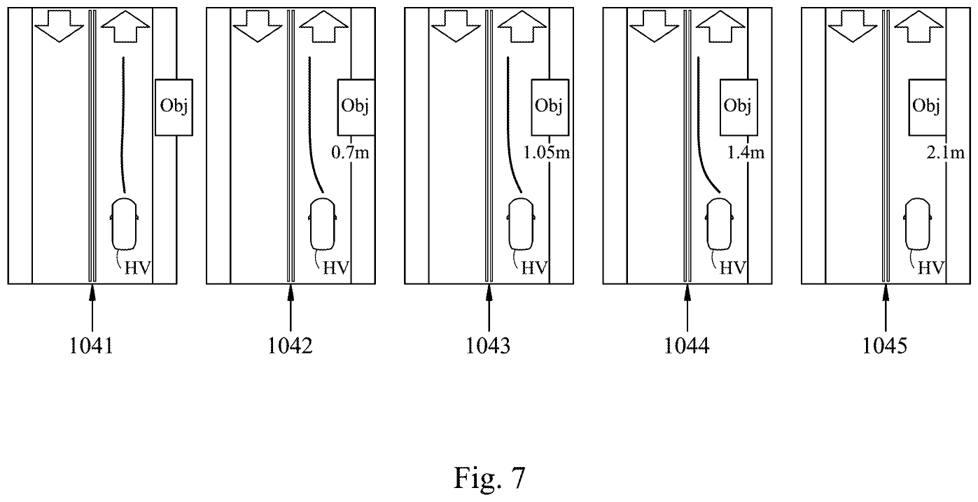

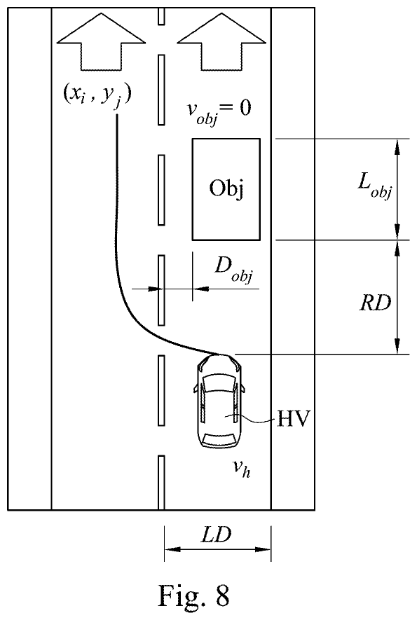

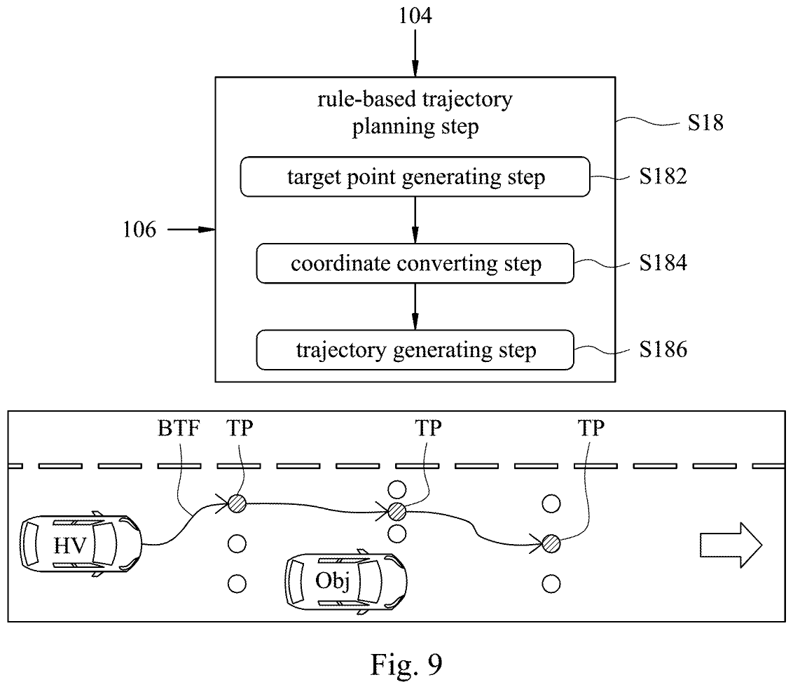

Please refer to FIGS. 2-9. FIG. 2 shows a flow chart of a hybrid planning method 100a in an autonomous vehicle according to a second embodiment of the present disclosure. FIG. 3 shows a schematic view of a message sensing step S122 of the hybrid planning method 100a in the autonomous vehicle of FIG. 2. FIG. 4 shows a schematic view of a plurality of input data and a plurality of output data 101 of the message sensing step S122 of the hybrid planning method 100a in the autonomous vehicle of FIG. 2. FIG. 5 shows a schematic view of a data processing step S124 of the hybrid planning method 100a in the autonomous vehicle of FIG. 2. FIG. 6 shows a schematic view of the hybrid planning method 100a in the autonomous vehicle of FIG. 2, applied to an object avoidance in the same lane. FIG. 7 shows a schematic view of the hybrid planning method 100a in the autonomous vehicle of FIG. 2, applied to an object occupancy scenario. FIG. 8 shows a schematic view of the hybrid planning method 100a in the autonomous vehicle of FIG. 2, applied to a lane change. FIG. 9 shows a schematic view of a rule-based trajectory planning step S18 of the hybrid planning method 100a in the autonomous vehicle of FIG. 2. The hybrid planning method 100a in the autonomous vehicle is performed to plan a best trajectory function 108 of a host vehicle HV. The autonomous vehicle is corresponding to the host vehicle HV. The hybrid planning method 100a in the autonomous vehicle includes performing a parameter obtaining step S12, a learning-based scenario deciding step S14, a learning-based parameter optimizing step S16, the rule-based trajectory planning step S18, a diagnosing step S20 and a controlling step S22.

The parameter obtaining step S12 is performed to drive a sensing unit to sense a surrounding scenario of the host vehicle HV to obtain a parameter group 102 to be learned and store the parameter group 102 to be learned to a memory. In detail, the parameter group 102 to be learned includes a road width LD, a relative distance RD, an object length L_{obj} and an object lateral distance D_{obj}. The road width LD represents a width of a road traveled by the host vehicle HV. The relative distance RD represents a distance between the host vehicle HV and an object Obj. The object length L_{obj} represents a length of the object Obj. The object lateral distance D_{obj} represents a distance between the object Obj and a center line of the road. In addition, the parameter obtaining step S12 includes the message sensing step S122 and the data processing step S124.

The message sensing step S122 includes performing a vehicle dynamic sensing step S1222, an object sensing step S1224 and a lane sensing step S1226. The vehicle dynamic sensing step S1222 is performed to drive a vehicle dynamic sensing device to position a current location of the host vehicle HV and a stop line of an intersection according to a map message, and sense a current heading angle, a current speed and a current acceleration of the host vehicle HV. The object sensing step S1224 is performed to drive an object sensing device to sense an object Obj within a predetermined distance from the host vehicle HV to generate an object message corresponding to the object Obj and a plurality of travelable space coordinate points corresponding to the host vehicle HV. The object message includes a current location of the object Obj, an object speed v_{obj} and an object acceleration. The lane sensing step S1226 is performed to drive a lane sensing device to sense a road curvature and a distance between the host vehicle HV and a lane line. In addition, the input data of the message sensing step S122 include a map message, a Global Positioning System (GPS) data, an image data, a lidar data, a radar data and an Inertial Measurement Unit (IMU) data, as shown in FIG. 4. The output data 101 include the current location of the host vehicle HV, the current heading angle, the stop line of an intersection, the current location of the object Obj, the object speed v_{obj}, the object acceleration, the travelable space coordinate points, the road curvature and the distance between the host vehicle HV and the lane line.

The data processing step S124 is implemented by a processing unit and includes performing a cutting step S1242, a grouping step S1244 and a mirroring step S1246. The cutting step S1242 is performed to cut the current location of the host vehicle HV, the current heading angle, the current speed, the current acceleration, the object message, the travelable space coordinate points, the road curvature and the distance between the host vehicle HV and the lane line to generate a cut data according to a predetermined time interval and a predetermined yaw rate change. There is a collision time interval between the host vehicle HV and the object Obj, and the host vehicle HV has a yaw rate. In response to determining that the collision time interval is smaller than or equal to the predetermined time interval, the cutting step S1242 is started. In response to determining that a change of the yaw rate is smaller than or equal to the predetermined yaw rate change, the cutting step S1242 is stopped. The predetermined time interval may be 3 seconds, and the predetermined yaw rate change may be 0.5. The changes of the yaw rates at multiple consecutive sampling timings can be comprehensively judged (e.g., the changes of the yaw rates at five consecutive sampling timings are all less than or equal to 0.5), but the present disclosure is not limited thereto. In addition, the grouping step S1244 is performed to group the cut data into a plurality of groups according to a plurality of predetermined acceleration ranges and a plurality of opposite object messages. The predetermined acceleration ranges include a predetermined conservative acceleration range and a predetermined normal acceleration range. The opposite object messages include an opposite object information and an opposite object-free information. The groups include a conservative group and a normal group. The predetermined conservative acceleration range and the opposite object-free information are corresponding to the conservative group, and the predetermined normal acceleration range and the opposite object information are corresponding to the normal group. The predetermined conservative acceleration range may be −0.1 g to 0.1 g. The predetermined normal acceleration range may be −0.2 g to −0.3 g and 0.2 g to 0.3 g, that is, 0.2 g≤|predetermined normal acceleration range|≤0.3 g, where g represents gravitational acceleration, but the present disclosure is not limited thereto. Therefore, the purpose of the grouping step S1244 is to distinguish the difference (conservative or normal) of driving behavior and improve the effectiveness of the training of the subsequent learning-based model. In addition, the grouping step S1244 can facilitate the switching of models or parameters, and enable the system to switch the acceleration within an executable range or avoid the object Obj. Moreover, the mirroring step S1246 is performed to mirror a vehicle trajectory function of the host vehicle HV along a vehicle traveling direction (e.g., a Y-axis) to generate a mirrored vehicle trajectory function according to each of the scenario categories 104. The parameter group 102 to be learned includes the mirrored vehicle trajectory function. The vehicle trajectory function is the trajectory traveled by the host vehicle HV and represents a driving behavior data. Accordingly, the vehicle trajectory function and the mirrored vehicle trajectory function in the mirroring step S1246 can be used for the training of the subsequent learning-based model to increase the diversity of collected data, thereby avoiding the problem of the inability to effectively distinguish the scenario categories 104 by the learning-based model due to insufficient diversity of data.

The learning-based scenario deciding step S14 is performed to drive the processing unit to receive the parameter group 102 to be learned from the memory and decide one of a plurality of scenario categories 104 that matches the surrounding scenario of the host vehicle HV according to the parameter group 102 to be learned and the learning-based model. In detail, the learning-based model is based on probability statistics and is trained by collecting real-driver driving behavior data. The learning-based model can include an end-to-end model or a sampling-based planning model. The scenario categories 104 include an object occupancy scenario, an intersection scenario and an entry/exit scenario. The object occupancy scenario has an object occupancy percentage. The object occupancy scenario represents that there are the object Obj and the road in the surrounding scenario, and the object occupancy percentage represents a percentage of the road occupied by the object Obj. For example, in FIG. 7, the scenario category 104 is the object occupancy scenario and includes a first scenario 1041, a second scenario 1042, a third scenario 1043, a fourth scenario 1044 and a fifth scenario 1045. The first scenario 1041 represents that the object Obj does not occupy the lane (i.e., the object occupancy percentage=0%). The second scenario 1042 represents that the object Obj has one third of the vehicle body occupying the lane (i.e., the object occupancy percentage=33.3̅% and one third of the vehicle body is 0.7 m). The third scenario 1043 represents that the object Obj has one half of the vehicle body occupying the lane (i.e., the object occupancy percentage=50%, and one half of the vehicle body is 1.05 m). The fourth scenario 1044 represents the object Obj has two thirds of the vehicle body occupying the lane (i.e., the object occupancy percentage=66.6̅%, and two thirds of the vehicle body is 1.4 m). The fifth scenario 1045 represents the object Obj occupies the lane by the entire vehicle body (i.e., the object occupancy percentage=100%, and the entire vehicle body is 2.1 m). In addition, the intersection scenario represents that there is an intersection in the surrounding scenario. When one of the scenario categories 104 is the intersection, the vehicle dynamic sensing device obtains the stop line of the intersection via the map message. The entry/exit scenario represents that there is an entry/exit station in the surrounding scenario. Therefore, the learning-based scenario deciding step S14 can obtain the scenario category 104 that matches the surrounding scenario for use in the subsequent rule-based trajectory planning step S18.

The learning-based parameter optimizing step S16 is performed to drive the processing unit to execute the learning-based model with the parameter group 102 to be learned to generate a key parameter group 106. In detail, the learning-based parameter optimizing step S16 includes performing a learning-based driving behavior generating step S162 and a key parameter generating step S164. The learning-based driving behavior generating step S162 is performed to generate a learned behavior parameter group 103 by learning the parameter group 102 to be learned according to the learning-based model. The learned behavior parameter group 103 includes a system action parameter group, a target point longitudinal distance, a target point lateral distance, a target point curvature and a target speed. The target speed represents a speed at which the host vehicle HV reaches a target point. A driving trajectory parameter group (xᵢ,yᵢ) and a driving acceleration/deceleration behavior parameter group can be obtained by the message sensing step S122. In other words, the parameter group 102 to be learned includes the driving trajectory parameter group (xᵢ,yᵢ) and the driving acceleration/deceleration behavior parameter group. In addition, the key parameter generating step S164 is performed to calculate a system action parameter group of the learned behavior parameter group 103 to obtain a system action time point, and combine the system action time point, the target point longitudinal distance, the target point lateral distance, the target point curvature, the vehicle speed vₕ and the target speed to form the key parameter group 106. The system action parameter group includes the vehicle speed vₕ, a vehicle acceleration, a steering wheel angle, the yaw rate, the relative distance RD and the object lateral distance D_{obj}.

The rule-based trajectory planning step S18 is performed to drive the processing unit to execute a rule-based model with the one of the scenario categories 104 and the key parameter group 106 to plan the best trajectory function 108. In detail, the one of the scenario categories 104 matches the current surrounding scenario of the host vehicle HV. The rule-based model is formulated according to definite behaviors, and the decision result depends on sensor information. The rule-based model includes polynomials or interpolation curves. In addition, the rule-based trajectory planning step S18 includes performing a target point generating step S182, a coordinate converting step S184 and a trajectory generating step S186. The target point generating step S182 is performed to drive the processing unit to generate a plurality of target points TP according to the scenario categories 104 and the key parameter group 106. The coordinate converting step S184 is performed to drive the processing unit to convert the target points TP into a plurality of two-dimensional target coordinates according to the travelable space coordinate points. The trajectory generating step S186 is performed to drive the processing unit to connect the two-dimensional target coordinates with each other to generate the best trajectory function 108. For example, in FIG. 9, the target point generating step S182 is performed to generate three target points TP, and then the coordinate converting step S184 is performed to convert the three target points TP into three two-dimensional target coordinates. Finally, the trajectory generating step S186 is performed to generate the best trajectory function 108 according to the three two-dimensional target coordinates. Moreover, the best trajectory function 108 includes a plane coordinate curve equation BTF, a tangent speed and a tangent acceleration. The plane coordinate curve equation BTF represents a best trajectory of the host vehicle HV on a plane coordinate, that is, a coordinate equation of the best trajectory function 108. The plane coordinate is corresponding to the road traveled by the host vehicle HV. The tangent speed represents a speed of the host vehicle HV at a tangent point of the plane coordinate curve equation BTF. The tangent acceleration represents an acceleration of the host vehicle HV at the tangent point. Furthermore, the parameter group 102 to be learned can be updated according to a sampling time of the processing unit, thereby updating the best trajectory function 108. In other words, the best trajectory function 108 can be updated according to the sampling time of the processing unit.

The diagnosing step S20 is performed to diagnose whether a future driving trajectory of the host vehicle HV and the current surrounding scenario (e.g., the current road curvature, the distance between the host vehicle HV and the lane line or the relative distance RD) are maintained within a safe error tolerance, and generate a diagnosis result to determine whether the automatic driving trajectory is safe. At the same time, the parameters that need to be corrected in the future driving trajectory can be directly determined and corrected by judging the plane coordinate curve equation BTF so as to improve the safety of automatic driving.

The controlling step S22 is performed to control a plurality of automatic driving parameters of the host vehicle HV according to the diagnosis result. The detail of the controlling step S22 is the conventional technology, and will not be described again herein.

Therefore, the hybrid planning method 100a in the autonomous vehicle of the present disclosure utilizes the learning-based model to learn the driving behavior of the object avoidance, and then combines the learning-based planning with the rule-based trajectory planning to construct a hybrid planning, so that the hybrid planning method 100a can not only process a plurality of multi-dimensional variables at the same time, but also be equipped with learning capabilities and conform to the continuity of trajectory planning and the dynamic constraints of the host vehicle HV.

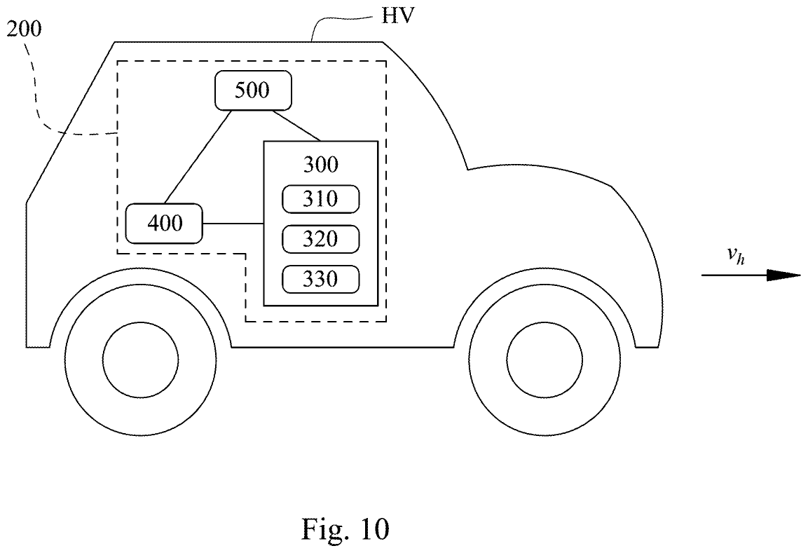

Please refer to FIGS. 2-10. FIG. 10 shows a block diagram of a hybrid planning system 200 in an autonomous vehicle according to a third embodiment of the present disclosure. The hybrid planning system 200 in the autonomous vehicle is configured to plan a best trajectory function 108 of a host vehicle HV and includes a sensing unit 300, a memory 400 and a processing unit 500.

The sensing unit 300 is configured to sense a surrounding scenario of the host vehicle HV to obtain a parameter group 102 to be learned. In detail, the sensing unit 300 includes a vehicle dynamic sensing device 310, an object sensing device 320 and a lane sensing device 330. The vehicle dynamic sensing device 310, the object sensing device 320 and the lane sensing device 330 are disposed on the host vehicle HV. The vehicle dynamic sensing device 310 is configured to position a current location of the host vehicle HV and a stop line of an intersection according to the map message, and sense a current heading angle, a current speed and a current acceleration of the host vehicle HV. The vehicle dynamic sensing device 310 includes a GPS, a gyroscope, an odometer, a speed meter and an IMU. In addition, the object sensing device 320 is configured to sense an object Obj within a predetermined distance from the host vehicle HV to generate an object message corresponding to the object Obj and a plurality of travelable space coordinate points corresponding to the host vehicle HV. The object message includes a current location of the object Obj, an object speed v_{obj} and an object acceleration. The lane sensing device 330 is configured to sense a road curvature and a distance between the host vehicle HV and a lane line. The object sensing device 320 and the lane sensing device 330 include a lidar, a radar and a camera. The detail of the structures of the object sensing device 320 and the lane sensing device 330 is the conventional technology, and will not be described again herein.

The memory 400 is configured to access the parameter group 102 to be learned, a plurality of scenario categories 104, a learning-based model and a rule-based model. The memory 400 is configured to access a map message related to a trajectory traveled by the host vehicle HV.

The processing unit 500 is electrically connected to the memory 400 and the sensing unit 300. The processing unit 500 is configured to implement the hybrid planning methods 100, 100a in the autonomous vehicle of FIGS. 1 and 2. The processing unit 500 may be a microprocessor, an electronic control unit (ECU), a computer, a mobile device or other computing processors.

Therefore, the hybrid planning system 200 in the autonomous vehicle of the present disclosure utilizes the learning-based model to learn the driving behavior of the object avoidance, and then combines the learning-based planning with the rule-based trajectory planning to construct a hybrid planning, so that the hybrid planning can not only process a plurality of multi-dimensional variables at the same time, but also be equipped with learning capabilities and conform to the dynamic constraints of the host vehicle HV and the continuity of trajectory planning.

According to the aforementioned embodiments and examples, the advantages of the present disclosure are described as follows.

1. The hybrid planning method in the autonomous vehicle and the system thereof of the present disclosure utilize the learning-based model to learn the driving behavior of the object avoidance, and then combine the learning-based planning with the rule-based trajectory planning to construct a hybrid planning, so that the hybrid planning can not only process a plurality of multi-dimensional variables at the same time, but also be equipped with learning capabilities and conform to the dynamic constraints of the host vehicle and the continuity of trajectory planning.

2. The hybrid planning method in the autonomous vehicle and the system thereof of the present disclosure utilize the rule-based model to plan the specific trajectory of the host vehicle according to the specific scenario categories and the specific key parameter group. The specific trajectory of the host vehicle is already the best trajectory so as to solve the problem of the need of additional selection of generating a plurality of trajectories and then selecting one of the trajectories in the prior art.

3. The hybrid planning method in the autonomous vehicle and the system thereof of the present disclosure can update the parameter group to be learned at any time according to the sampling time of the processing unit, and then update the best trajectory function at any time, thereby greatly improving the safety and practicability of automatic driving.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A hybrid planning method in an autonomous vehicle, which is performed to plan a best trajectory function of a host vehicle, and the hybrid planning method in the autonomous vehicle comprising:
performing a parameter obtaining step to drive a sensing unit to sense a surrounding scenario of the host vehicle to obtain a parameter group to be learned and store the parameter group to be learned to a memory;
performing a learning-based scenario deciding step to drive a processing unit to receive the parameter group to be learned from the memory and decide one of a plurality of scenario categories that matches the surrounding scenario of the host vehicle according to the parameter group to be learned and a learning-based model;
performing a learning-based parameter optimizing step to drive the processing unit to execute the learning-based model with the parameter group to be learned to generate a key parameter group; and
performing a rule-based trajectory planning step to drive the processing unit to execute a rule-based model with the one of the scenario categories and the key parameter group to plan the best trajectory function.

2. The hybrid planning method in the autonomous vehicle of claim 1, wherein the parameter group to be learned comprises:
a road width representing a width of a road traveled by the host vehicle;
a relative distance representing a distance between the host vehicle and an object;
an object length representing a length of the object; and
an object lateral distance representing a distance between the object and a center line of the road.

3. The hybrid planning method in the autonomous vehicle of claim 1, wherein the parameter obtaining step comprises:
performing a message sensing step, wherein the information sensing step comprises:
performing a vehicle dynamic sensing step to drive a vehicle dynamic sensing device to position a current location of the host vehicle and a stop line of an intersection according to a map message, and sense a current heading angle, a current speed and a current acceleration of the host vehicle;
performing an object sensing step to drive an object sensing device to sense an object within a predetermined distance from the host vehicle to generate an object message corresponding to the object and a plurality of travelable space coordinate points corresponding to the host vehicle, wherein the object message comprises a current location of the object, an object speed and an object acceleration; and
performing a lane sensing step to drive a lane sensing device to sense a road curvature and a distance between the host vehicle and a lane line.

4. The hybrid planning method in the autonomous vehicle of claim 3, wherein the parameter obtaining step further comprises:
performing a data processing step, wherein the data processing step is implemented by the processing unit and comprises:
performing a cutting step to cut the current location of the host vehicle, the current heading angle, the current speed, the current acceleration, the object message, the travelable space coordinate points, the road curvature and the distance between the host vehicle and the lane line to generate a cut data according to a predetermined time interval and a predetermined yaw rate change;
wherein there is a collision time interval between the host vehicle and the object, and the host vehicle has a yaw rate;
in response to determining that the collision time interval is smaller than or equal to the predetermined time interval, the cutting step is started; and
in response to determining that a change of the yaw rate is smaller than or equal to the predetermined yaw rate change, the cutting step is stopped.

5. The hybrid planning method in the autonomous vehicle of claim 4, wherein the data processing step further comprises:
performing a grouping step to group the cut data into a plurality of groups according to a plurality of predetermined acceleration ranges and a plurality of opposite object messages, the predetermined acceleration ranges comprise a predetermined conservative acceleration range and a predetermined normal acceleration range, the opposite object messages comprise an opposite object information and an opposite object-free information, the groups comprise a conservative group and a normal group, the predetermined conservative acceleration range and the opposite object-free information are corresponding to the conservative group, and the predetermined normal acceleration range and the opposite object information are corresponding to the normal group.

6. The hybrid planning method in the autonomous vehicle of claim 4, wherein the data processing step further comprises:
performing a mirroring step to mirror a vehicle trajectory function of the host vehicle along a vehicle traveling direction to generate a mirrored vehicle trajectory function according to each of the scenario categories, wherein the parameter group to be learned comprises the mirrored vehicle trajectory function.

7. The hybrid planning method in the autonomous vehicle of claim 1, wherein the learning-based parameter optimizing step comprises:
performing a learning-based driving behavior generating step to generate a learned behavior parameter group by learning the parameter group to be learned according to the learning-based model, wherein the parameter group to be learned comprises a driving trajectory parameter group and a driving acceleration/deceleration behavior parameter group; and
performing a key parameter generating step to calculate a system action parameter group of the learned behavior parameter group to obtain a system action time point, and combine the system action time point, a target point longitudinal distance, a target point lateral distance, a target point curvature, a vehicle speed and a target speed to form the key parameter group.

8. The hybrid planning method in the autonomous vehicle of claim 7, wherein,
the learned behavior parameter group comprises the system action parameter group, the target point longitudinal distance, the target point lateral distance, the target point curvature and the target speed; and
the system action parameter group comprises the vehicle speed, a vehicle acceleration, a steering wheel angle, a yaw rate, a relative distance and an object lateral distance.

9. The hybrid planning method in the autonomous vehicle of claim 1, wherein the best trajectory function comprises:
a plane coordinate curve equation representing a best trajectory of the host vehicle on a plane coordinate;
a tangent speed representing a speed of the host vehicle at a tangent point of the plane coordinate curve equation; and
a tangent acceleration representing an acceleration of the host vehicle at the tangent point;
wherein the best trajectory function is updated according to a sampling time of the processing unit.

10. The hybrid planning method in the autonomous vehicle of claim 1, wherein the scenario categories comprise:
an object occupancy scenario having an object occupancy percentage, wherein the object occupancy scenario represents that there are an object and a road in the surrounding scenario, and the object occupancy percentage represents a percentage of the road occupied by the object;
an intersection scenario representing that there is an intersection in the surrounding scenario; and
an entry/exit scenario representing that there is an entry/exit station in the surrounding scenario.

11. A hybrid planning system in an autonomous vehicle, which is configured to plan a best trajectory function of a host vehicle, and the hybrid planning system in the autonomous vehicle comprising:
a sensing unit configured to sense a surrounding scenario of the host vehicle to obtain a parameter group to be learned;
a memory configured to access the parameter group to be learned, a plurality of scenario categories, a learning-based model and a rule-based model; and
a processing unit electrically connected to the memory and the sensing unit, wherein the processing unit is configured to implement a hybrid planning method in the autonomous vehicle comprising:
performing a learning-based scenario deciding step to decide one of the scenario categories that matches the surrounding scenario of the host vehicle according to the parameter group to be learned and the learning-based model;
performing a learning-based parameter optimizing step to execute the learning-based model with the parameter group to be learned to generate a key parameter group; and
performing a rule-based trajectory planning step to execute the rule-based model with the one of the scenario categories and the key parameter group to plan the best trajectory function.

12. The hybrid planning system in the autonomous vehicle of claim 11, wherein the parameter group to be learned comprises:
a road width representing a width of a road traveled by the host vehicle;
a relative distance representing a distance between the host vehicle and an object;
an object length representing a length of the object; and
an object lateral distance representing a distance between the object and a center line of the road.

13. The hybrid planning system in the autonomous vehicle of claim 11, wherein,
the memory configured to access a map message related to a trajectory traveled by the host vehicle; and
the sensing unit comprising:
a vehicle dynamic sensing device configured to position a current location of the host vehicle and a stop line of an intersection according to the map message, and sense a current heading angle, a current speed and a current acceleration of the host vehicle;
an object sensing device configured to sense an object within a predetermined distance from the host vehicle to generate an object message corresponding to the object and a plurality of travelable space coordinate points corresponding to the host vehicle, wherein the object message comprises a current location of the object, an object speed and an object acceleration; and
a lane sensing device configured to sense a road curvature and a distance between the host vehicle and a lane line.

14. The hybrid planning system in the autonomous vehicle of claim 13, wherein the processing unit is configured to implement a data processing step, and the data processing step comprises:
performing a cutting step to cut the current location of the host vehicle, the current heading angle, the current speed, the current acceleration, the object message, the travelable space coordinate points, the road curvature and the distance between the host vehicle and the lane line to generate a cut data according to a predetermined time interval and a predetermined yaw rate change;
wherein there is a collision time interval between the host vehicle and the object, and the host vehicle has a yaw rate;
in response to determining that the collision time interval is smaller than or equal to the predetermined time interval, the cutting step is started; and
in response to determining that a change of the yaw rate is smaller than or equal to the predetermined yaw rate change, the cutting step is stopped.

15. The hybrid planning system in the autonomous vehicle of claim 14, wherein the data processing step further comprises:
performing a grouping step to group the cut data into a plurality of groups according to a plurality of predetermined acceleration ranges and a plurality of opposite object messages, the predetermined acceleration ranges comprise a predetermined conservative acceleration range and a predetermined normal acceleration range, the opposite object messages comprise an opposite object information and an opposite object-free information, the groups comprise a conservative group and a normal group, the predetermined conservative acceleration range and the opposite object-free information are corresponding to the conservative group, and the predetermined normal acceleration range and the opposite object information are corresponding to the normal group.

16. The hybrid planning system in the autonomous vehicle of claim 14, wherein the data processing step further comprises:
performing a mirroring step to mirror a vehicle trajectory function of the host vehicle along a vehicle traveling direction to generate a mirrored vehicle trajectory function according to each of the scenario categories, wherein the parameter group to be learned comprises the mirrored vehicle trajectory function.

17. The hybrid planning system in the autonomous vehicle of claim 11, wherein the learning-based parameter optimizing step comprises:
performing a learning-based driving behavior generating step to generate a learned behavior parameter group by learning the parameter group to be learned according to the learning-based model, wherein the parameter group to be learned comprises a driving trajectory parameter group and a driving acceleration/deceleration behavior parameter group; and
performing a key parameter generating step to calculate a system action parameter group of the learned behavior parameter group to obtain a system action time point, and combine the system action time point, a target point longitudinal distance, a target point lateral distance, a target point curvature, a vehicle speed and a target speed to form the key parameter group.

18. The hybrid planning system in the autonomous vehicle of claim 17, wherein,
the learned behavior parameter group comprises the system action parameter group, the target point longitudinal distance, the target point lateral distance, the target point curvature and the target speed; and
the system action parameter group comprises the vehicle speed, a vehicle acceleration, a steering wheel angle, a yaw rate, a relative distance and an object lateral distance.

19. The hybrid planning system in the autonomous vehicle of claim 11, wherein the best trajectory function comprises:
a plane coordinate curve equation representing a best trajectory of the host vehicle on a plane coordinate;
a tangent speed representing a speed of the host vehicle at a tangent point of the plane coordinate curve equation; and
a tangent acceleration representing an acceleration of the host vehicle at the tangent point;
wherein the best trajectory function is updated according to a sampling time of the processing unit.

20. The hybrid planning system in the autonomous vehicle of claim 11, wherein the scenario categories comprise:
an object occupancy scenario having an object occupancy percentage, wherein the object occupancy scenario represents that there are an object and a road in the surrounding scenario, and the object occupancy percentage represents a percentage of the road occupied by the object;
an intersection scenario representing that there is an intersection in the surrounding scenario; and
an entry/exit scenario representing that there is an entry/exit station in the surrounding scenario.
